(19) United States
(12) Patent Application Publication
(10) Pub. No.: US 2013/0080141 A1
(43) Pub. Date: Mar. 28, 2013

(54) POWER AWARE SIMULATION SYSTEM WITH EMBEDDED MULTI-CORE DSP

(71) Applicants: JENQ KUEN LEE, TAINAN CITY (TW); PO YU CHEN, HSINCHU (TW); CHENG YEN LIN, HSINCHU (TW)

(72) Inventors: JENQ KUEN LEE, TAINAN CITY (TW); PO YU CHEN, HSINCHU (TW); CHENG YEN LIN, HSINCHU (TW)

(73) Assignee: NATIONAL TSING HUA UNIVERSITY, HSINCHU (TW)

(21) Appl. No.: 13/614,263

(22) Filed: Sep. 13, 2012

Related U.S. Application Data
(60) Provisional application No. 61/538,543, filed on Sep. 23, 2011.

(51) Int. Cl. G06F 17/50

(52) U.S. Cl. 703/21

(57) ABSTRACT

The current disclosure discloses a power aware simulation system comprising an embedded multi-core simulation module, a power abstract interpretation module and a C power estimation (CPE) power profiling module. The embedded multi-core simulation module comprises a plurality of digital signal processors (DSP), an external memory and a direct memory access. Each of the plurality of DSPs comprises a DSP core, an instruction cache and a local memory. The power abstract interpretation module is coupled to the plurality of DSPs, the external memory, the DMA and the CPE profiling module, respectively.

### BACKGROUND

1. Technical Field

The current disclosure relates to a simulation system and, in particular, to a power aware simulation system with embedded multi-core DSPs and method thereof.

2. Description of Related Arts

Embedded multi-core DSP systems currently play an important role in consumer electronic design. Such systems attempt to optimize the performance and the power capacity of mobile devices. Power optimization is necessary for battery-based mobile devices and has to meet all levels, such as production, place and route, RTL synthesis, architecture design, system design, system software design, and application design.

Developers of embedded applications for battery-based mobile devices have to balance performance and power consumption of embedded applications, while developing them via an application simulation platform such as QEMU and SID. However, current simulation platforms are not capable of supporting power metrics. This will increase the difficulties in optimizing power consumption during the development of embedded applications since the current simulation platforms do not allow developers to estimate the power consumption of applications.

Therefore, in order to solve these problems, the current disclosure discloses a power aware simulation system and method thereof.

### SUMMARY

In accordance with one embodiment of the current disclosure, a power aware simulation system comprises an embedded multi-core simulation module, a power abstract interpretation module and a C power estimation (CPE) profiling module. The embedded multi-core simulation module comprises a plurality of digital signal processors (DSP), an external memory and a direct memory access. The power abstract interpretation module is coupled to the plurality of DSPs, the external memory, the DMA and the CPE profiling module, respectively. The CPE profiling module comprises a plurality of IP power models for various IPs. The power abstract interpretation module is configured to summarize and interpret a plurality of simulation execution traces, from the embedded multi-core simulation module, in order to convert the simulation execution traces into a power estimation format.

In accordance with one embodiment of the current disclosure, each of the plurality of DSPs comprises a DSP core, an instruction cache and a local memory, wherein the DSP core is configured to couple to the instruction cache and the local memory, respectively.

In accordance with one embodiment of the current disclosure, the power aware simulation system further comprises a configurable interconnection module, a micro-processing unit (MPU) and a plurality of hardware components. The plurality of DSPs, the external memory and the DMA communicate with the MPU and the hardware components via the configurable interconnection module.

In accordance with one embodiment of the current disclosure, the DSP comprises a pipeline very long instruction word (VLIW) embedded processor.

In accordance with one embodiment of the current disclosure, the external memory comprises a DRAM.

In accordance with one embodiment of the current disclosure, the CPE profiling module includes an algorithm.

In accordance with one embodiment of the current disclosure, the configurable interconnection module comprises a bus.

In accordance with one embodiment of the current disclosure, the configurable interconnection module comprises a crossbar.

In accordance with one embodiment of the current disclosure, the configurable interconnection module comprises a network-on-chip.

In accordance with one embodiment of the current disclosure, the DMA is configured to record information of active and idle modes into a simulation execution trace.

In accordance with one embodiment of the current disclosure, the simulation execution traces further comprises information of an instruction type, counts of a pipeline stage, counts of hits and misses of an instruction cache, and/or counts of read/write of a local memory.

In accordance with one embodiment of the current disclosure, a method of power aware simulation comprising the steps of receiving an simulation execution trace; converting the simulation execution traces into a power estimation format; mapping a power profiling point into a location of a program counter, wherein the location is corresponding to a program; generating a mapping table which includes a plurality of control parameters, wherein each of the plurality of control parameters is corresponding to the program; and generating a power estimation result.

In accordance with one embodiment of the current disclosure, the simulation execution trace comprises information of an instruction type, counts of a pipeline stage, counts of hits and misses of an instruction cache, and/or counts of read/write of a local memory

In order to provide further understanding of the techniques, means, and effects of the current disclosure, the following detailed description and drawings are hereby presented, such that the purposes, features and aspects of the current disclosure may be thoroughly and concretely appreciated; however, the drawings are provided solely for reference and illustration, without any intention to be used for limiting the current disclosure.

### BRIEF DESCRIPTION OF THE DRAWINGS

A more complete understanding of the current disclosure may be derived by referring to the detailed description and claims when considered in connection with the Figures, where like reference numbers refer to similar elements throughout the Figures, and:

FIG. 1 is a schematic view of a power aware simulation system of one embodiment of the current disclosure;

FIG. 2 is a schematic view of a configuration of a DSP of the power aware simulation system;

FIG. 3 shows the algorithm of the CPE profiling module;

FIG. 4 shows a running example for the algorithm in the CPE profiling module; and

FIG. 5 shows a flow chart of a method of power aware simulation.

### DETAILED DESCRIPTION

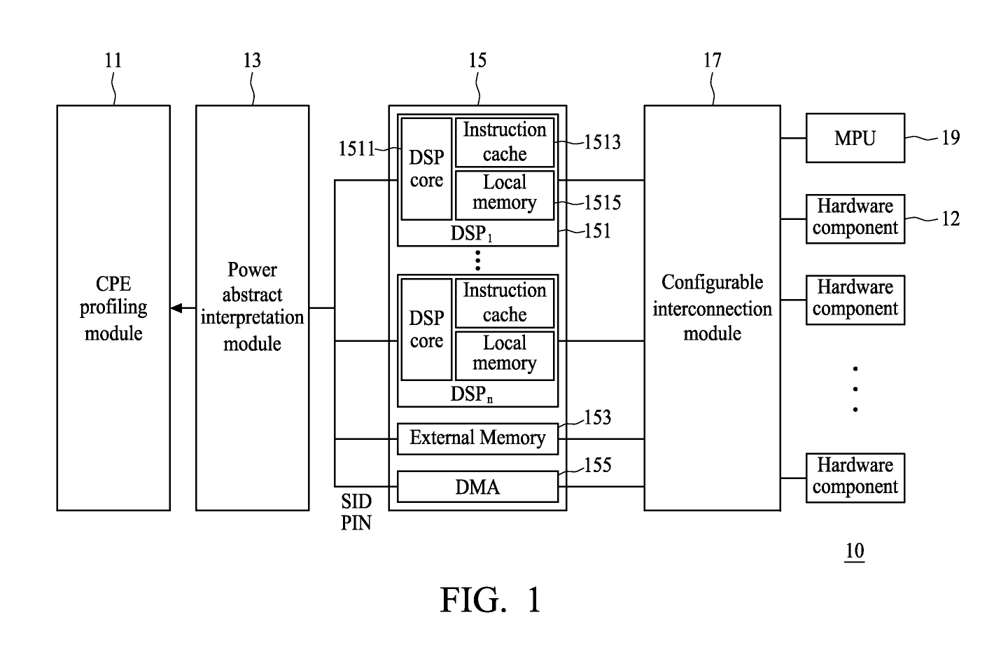

FIG. 1 is a schematic view of a power aware computer simulation system of one embodiment of the current disclosure. The power aware simulation system 10 includes an embedded multi-core simulation module 15, a power abstract interpretation module 13, a C power estimation (CPE) profiling module 11, a configurable interconnection module 17, a micro-processing unit (MPU) 19 and a plurality of hardware components 12. The CPE profiling module 11 may include an algorithm.

The MPU 19 is configured to control the embedded multi-core simulation module 15 and the plurality of hardware components 12. The CPE profiling module 11 comprises a plurality of IP power models for various IPs, which were generated in a previous stage called IP-Level power modeling stage; moreover, the IP power models may be generated according to the following table 1. The various IPs may include DSPs, SRAM, DRAM, bus, bridges, and DMA. During the IP-Level power modeling stage, a PowerMixer^{IP}, a product of Tinno Tek Inc., may be employed to build the plurality of IP power models.

TABLE 1
Instruction classes of DSP in power classifications

| #ID | Instruction name |
|---|---|
| 0 | INVALID, VERSION |
| 1 | SWAP4, UNPACK4U, PERMH2, SWAP4E, PERMH, |
| | PACK2, PACK2, UNPACK2, PACK4 . . . |
| 2 | MOV1.H, LIMBCP, MOV1.L |
| 3 | MOV1.U. MOV1U.H, LIMBUCP |
| 4 | COPY_FC, COPY_FY |
| 5 | COPY |
| 6 | DMAX, MAXU, DMIN, MIN, SEQ. SGTI, SLT, SLTI, |
| | SLT.H, SLTIO, SEQ1, SETO.L . . . |
| 7 | ABS, ABS.D, ADD.D, ADD,DS, ADDI, ADDLD, |
| | ADDLDS, ADDU, ADDU.D, ADDU.DS, NEG, SUB, |
| | SUB.D, SUBS, MERGES, ADDC, ADDCU . . . |
| 8 | AND, NOT, ROR, EXTRACT, INSERT, NOTP, OR, |
| | ORP, SLL, SRA, SRL, XOR, XORP . . . |
| 9 | FMUL, FMULuuD, XFMULus |
| 10 | FMAC, FMACuuD |
| 11 | LB, LBU |
| 12 | DLH, DLRU, LH, LRC |
| 13 | LW, LNWU, DLNW, DLW |
| 14 | SB, DSB |
| 15 | SH, SH, DSH, DSH |
| 16 | SW, SNW |
| 17 | BDR, BDT, CLR, DBDR, DDEX, DEX, LMBD, SFRA . . . |
| 18 | NOP |
| 19 | ROE, TRAP |
| 20 | TEST, WAIT |
| 21 | BRR, B, ER |
| 22 | LBCB |

The embedded multi-core simulation module 15 further comprises a plurality of digital signal processors (DSP₁-DSPₙ) 151, an external memory 153 and a direct memory access (DMA) 155. Each of the plurality of DSPs 151 comprises a DSP core 1511, an instruction cache 1513 and a local memory 1515. The power abstract interpretation module 13 is coupled to the plurality of DSPs 151, the external memory 153, the DMA 155 and the CPE profiling module 11, respectively.

The plurality of DSPs, the external memory 153 and the DMA 155 communicate with the MPU 19 and the plurality of hardware components 12 via the configurable interconnection module 17. The external memory 153 may comprise a DRAM. Moreover, the configurable interconnection module 17 may comprise a bus, a crossbar or a network-on-chip (NOC). The DSP 151 may comprise a pipeline very long instruction word (VLIW) embedded processor. The information of active and idle modes of DMA is recorded into a simulation execution trace of the power aware simulation system.

The power abstract interpretation module 13 may comprises a software model component, which may be configured to communicate with the DSPs 151, the external memory 153, and the DMA 155. The power abstract interpretation module 13 may summarize and interpret a plurality of simulation execution traces, and convert the execution traces into a power estimation format, wherein the simulation execution traces may contain power propriety information for a target system IP. The power propriety information may include related parameters of target hardware model component, of the power aware simulation system.

Table 2 provides IP name and parameters. Therefore, DSP users could configure voltage, frequency, size of the instruction cache 1513, and local memory 1515 of DSP.

TABLE 2
IP names and parameters

| IP Name | Parameters |
|---|---|
| PAC DSP Core | Voltage, Frequency |
| Instruction cache | Size, Voltage, Frequency |
| Local memory | Size, Voltage, Frequency |
| External Memory | Size, Voltage, Frequency |
| DMA | Voltage, Frequency |
| BUS | Connection Type |

In consideration of simulation speed, the power abstract interpretation module 13 may be implemented as a passive component and may only be activated, while the CPE profiling module 11 is set on by the user. While the CPE profiling module 11 is enabled, the target hardware components would dump a plurality of simulation execution traces to the power abstract interpretation module 13, furthermore, the number of read/write summarized in every specific simulation period, configured by the user, may be stored in the external memory 153.

Moreover, after interpreting the simulation execution traces, the simulation execution traces with the power estimation format may be transmitted to the CPE profiling module 11 by an inter-procedural communication (IPC) (not shown) on a host machine.

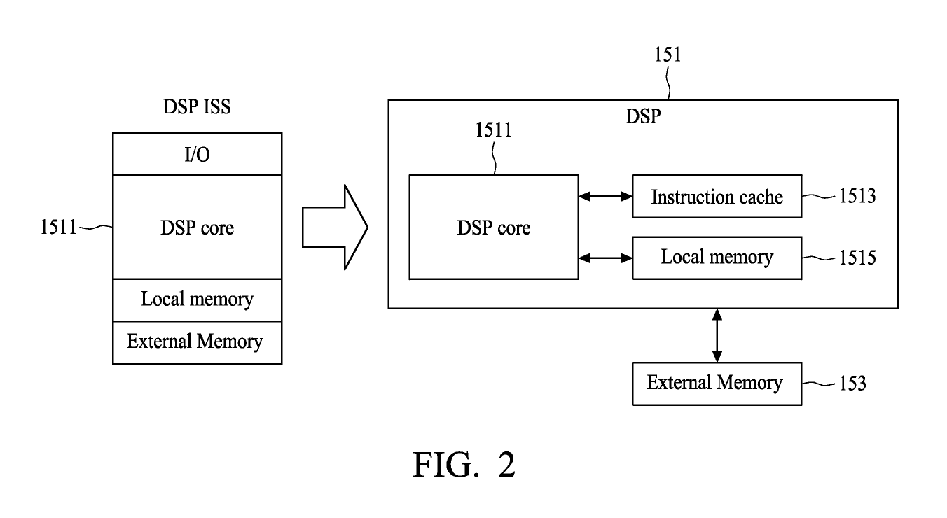

FIG. 2 is a schematic view of a configuration of a DSP of the power aware simulation computer system. As shown in FIG. 2, the DSP core 1511 may be separated from an instruction set simulator (ISS) of a DSP and is coupled to the instruction cache 1513 and the local memory 1515, respectively.

Referring to FIG. 1, the power abstract interpretation module 13 may receive a simulation execution trace which may be from the embedded multi-core simulation module 15 and the simulation execution trace may be regenerated as a simulation execution trace with a power estimation format. The simulation execution trace may comprise information of an instruction type, counts of a pipeline stage, counts of hits and misses of an instruction cache, and/or counts of read/write of a local memory. Next, the simulation execution trace with the power estimation format may be transmitted to the CPE profiling module 11.

In the CPE profiling module 11, a power profiling point of the simulation execution trace may be mapped into an address of a program counter, wherein the address corresponds to a program. Later, a mapping table which includes a plurality of control parameters may be generated, wherein each of the plurality of control parameters is corresponding to the program. Finally, a power estimation result may be generated, wherein the power estimation result may be presented as a plain text or power waveforms for each of the plurality of hardware components.

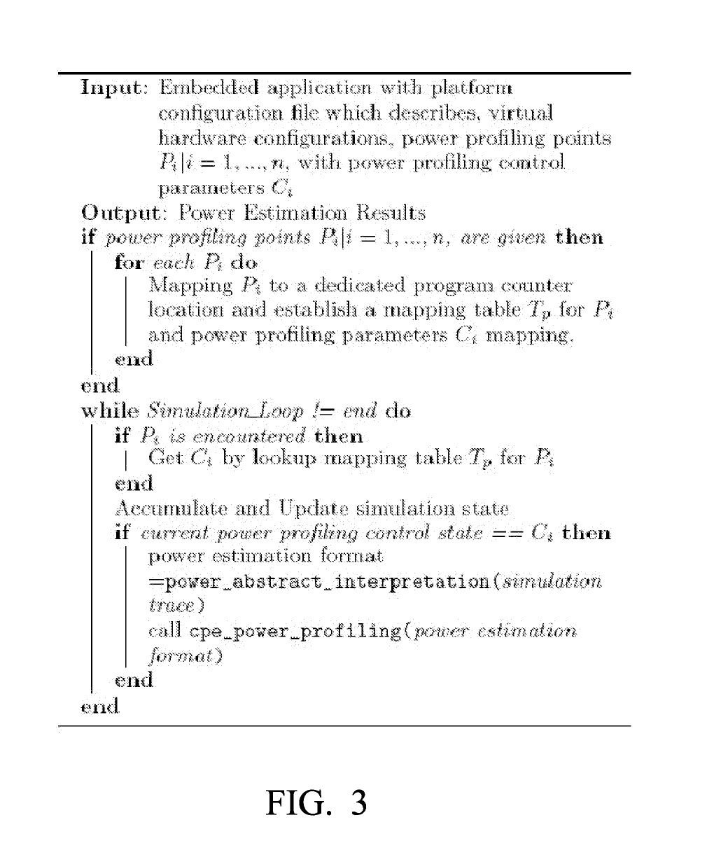

FIG. 3 shows the algorithm in the CPE profiling module 11. A plurality of power profiling points Pᵢ with control parameters Cᵢ are given by the user. Users can change the granularity of the power profiling at any program addresses in the source code. The CPE profiling module 11 may map Pᵢ into a program address in order to establish a mapping table Tₚ for looking up Cᵢ. Then, the granularity of power profiling could be changed according to the user's demand during the simulation process.

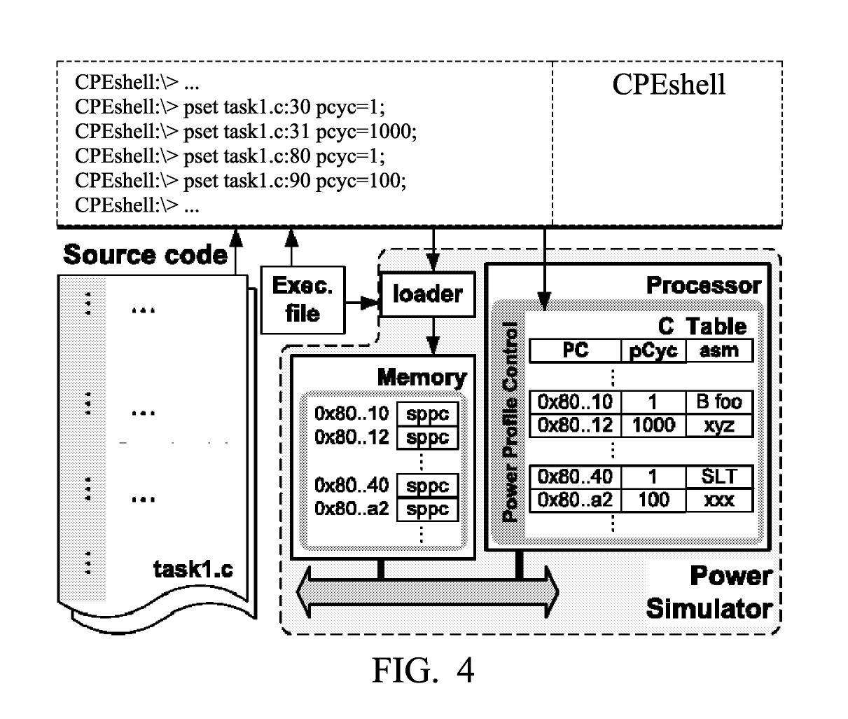

FIG. 4 shows a running example for the algorithm in the CPE profiling module 11. As shown in FIG. 4, users could setup a plurality of power profiling points Pᵢ with the control parameters Cᵢ for a simulation execution trace input to the CPE profiling module 11 through the CPEshell. After the plurality of power profiling points Pᵢ with the plurality of control parameters Cᵢ for the input simulation execution trace have been setup, in the CPE profiling module 11, each of the power profiling points Pᵢ was mapped into an address of a program counter (PC) and then a mapping table (C table), for looking up Cᵢ, may be generated.

When a simulation stage encounters a plurality of addresses, a plurality of related power control parameters would be retrieved by looking up the mapping table, therefore, the power profiling granularity may be changed according to the related power control parameters.

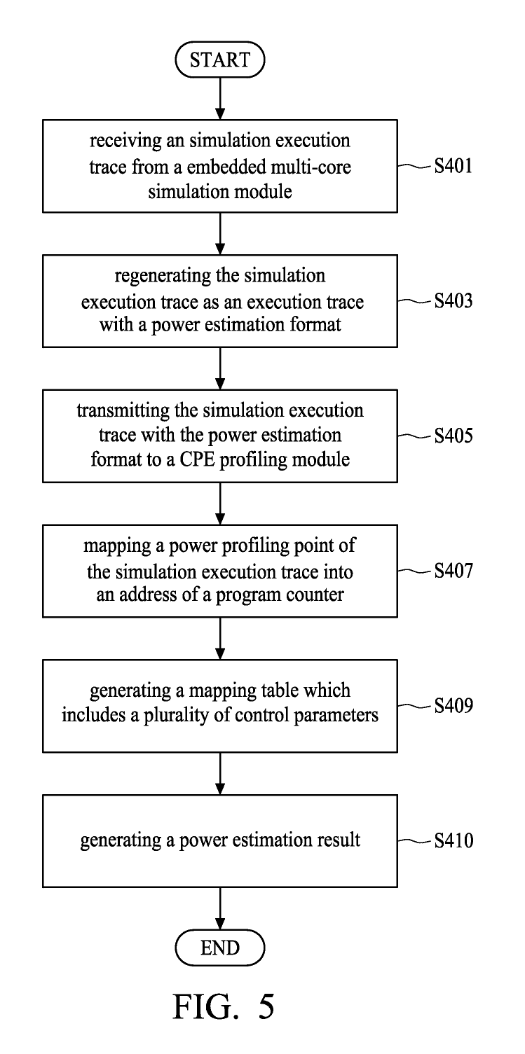

Therefore, FIG. 5 shows a flow chart of a method of power aware simulation. As shown in FIG. 5, step S401, a simulation execution trace from an embedded multi-core simulation module may be received at a power abstract interpretation module. Step S403, in the power abstract interpretation module, the simulation execution trace may be regenerated as a simulation execution trace with a power estimation format. Step S405, the simulation execution trace with the power estimation format may be transmitted to a CPE profiling module. Step S407, in the CPE profiling module, a power profiling point of the simulation execution trace may be mapped into an address of a program counter. Step S409, a mapping table which includes a plurality of control parameters may be generated, wherein each of the plurality of control parameters is corresponding to a program. Step S410, a power estimation result may be generated.

Although the current disclosure and its objectives have been described in detail, it should be understood that various changes, substitutions and alterations can be made herein without departing from the spirit and scope of the disclosure as defined by the appended claims. For example, many of the processes discussed above can be implemented using different methodologies, replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the current disclosure, processes, machines, manufacture, compositions of matter, means, methods, or steps, presently existing or later to be developed, that perform substantially the same function or achieve substantially the same result as the corresponding embodiments described herein may be utilized according to the current disclosure. As such, the appended claims are intended to include within their scope such processes, machines, manufacture, compositions of matter, means, methods, or steps.

What is claimed is:

1. A power aware simulation computer system, comprising:
an embedded multi-core simulation module comprises:
a plurality of digital signal processors (DSP₁-DSPₙ);
an external memory; and
a direct memory access (DMA);
a power abstract interpretation module; and
a C power estimation (CPE) power profiling module;
wherein the power abstract interpretation module is coupled to the plurality of DSPs, the external memory, the DMA and the CPE profiling module, respectively; and
wherein the CPE profiling module comprises a plurality of IP power models for various IPs;
wherein the power abstract interpretation module is configured is to summarize and interpret a plurality of simulation execution traces, from the embedded multi-core simulation module, into a power estimation format.

2. The power aware simulation system of claim 1 further comprises:
a configurable interconnection module;
a micro-processing unit (MPU); and
a plurality of hardware components;
wherein the plurality of DSPs, the external memory, and the DMA communicate with the MPU and the hardware components via the configurable interconnection module;
wherein the MPU is configured to control the embedded multi-core simulation module and the plurality of hardware components.

3. The power aware simulation system of claim 1, wherein each of the DSPs comprises:
a DSP core;
an instruction cache; and
a local memory;
wherein the DSP core is configured to couple to the instruction cache and the local memory, respectively.

4. The power aware simulation system of claim 1, wherein the DSP comprises a pipeline very long instruction word (VLIW) embedded processor.

5. The power aware simulation system of claim 1, wherein the external memory comprises a DRAM.

6. The power aware simulation system of claim 1, wherein the CPE profiling module includes an algorithm.

7. The power aware simulation system of claim 2, wherein the configurable interconnection module comprises a bus.

8. The power aware simulation system of claim 2, wherein the configurable interconnection module comprises a crossbar.

9. The power aware simulation system of claim 2, wherein the configurable interconnection module comprises a network-on-chip.

10. The power aware simulation system of claim 1, wherein the information of active and idle modes of DMA is recorded into a simulation execution trace of the power aware simulation system.

11. The power aware simulation system of claim 10, wherein the simulation execution trace further comprises information of an instruction type, counts of a pipeline stage, counts of hits and misses of an instruction cache, and/or counts of read/write of a local memory.

12. The power aware simulation system of claim 1, wherein the power abstract interpretation module comprises a software model component which is configured to communicate with the digital signal processors, the external memory and the DMA.

13. The power aware simulation system of claim 1, wherein the simulation execution traces with the power estimation format is comprises power propriety information for a target system IP.

14. A method of power aware simulation comprising the steps of:
receiving a simulation execution trace;
converting the simulation execution trace into a power estimation format;
mapping a power profiling point of the simulation execution trace into a location of a program counter, wherein the location is corresponding to a program;
generating a mapping table, which includes a plurality of control parameters, wherein each of the plurality of control parameters is corresponding to the program; and
generating a power estimation result.

15. The method of power aware simulation of claim 14, wherein the simulation execution trace comprises information of an instruction type, counts of a pipeline stage, counts of hits and misses of an instruction cache, and/or counts of read/write of a local memory.
